(19) United States
(12) Patent Application Publication
(10) Pub. No.: US 2011/0144916 A1
(43) Pub. Date: Jun. 16, 2011

(54) COMPUTER METHOD AND APPARATUS FOR CLASSIFYING OBJECTS

(75) Inventor: Peter Keck, Millbury, MA (US)

(73) Assignee: THRASOS THERAPEUTICS, INC., Montreal (CA)

(21) Appl. No.: 12/967,603

(22) Filed: Dec. 14, 2010

Related U.S. Application Data
(63) Continuation of application No. 12/319,731, filed on Jan. 12, 2009, now abandoned.
Application No. 12/319,731 is a continuation of application No. 10/430,685, filed on May 6, 2003, now abandoned.
Application No. 10/430,685 is a continuation of application No. PCT/US01/44000, filed on Nov. 6, 2001.
(60) Provisional application No. 60/246,196, filed on Nov. 6, 2000.

(51) Int. Cl. G06F 17/18; G06F 19/00

(52) U.S. Cl. 702/19; 702/181

(57) ABSTRACT

A computer classification method and apparatus employs statistical analysis of known objects in the class of interest. For each known object in the class, a respective vector of q bits is formed. Each bit indicates presence or absence of an activity or physical property in the object. The probability that a bit is equal to 1 in the class is then applied to vector representations of test objects and determines probability of the test object belonging, to the class.

### RELATED APPLICATION

This application is a continuation of PCT/U.S. 01/44000, filed Nov. 6, 2001 and claims the benefit of U.S. Provisional Application No. 60/246,196, filed Nov. 6, 2000, the entire teachings of which are incorporated herein by reference.

### BACKGROUND OF THE INVENTION

In this age of information, the development of objective and automated methods for information synthesis is crucial to the productive use of the information. In particular, in the post genomic age when masses of information about genes and the proteins for which they code are being developed, there is a great need for methods by which this information can be reliably synthesized to produce knowledge.

### SUMMARY OF THE INVENTION

In the present method, given a collection of similar objects, some of which possess an activity, some of which lack it and rest of which are unclassified, the active and inactive sets are used to aenerate a profile which can be used to classify the unclassified objects and also to identify features that are significantly correlated and anti-correlated with activity. The method employs Bayesian statistics and a binary representation of objects in order to generate a profile of the active class. By employing standard statistical techniques in a novel manner, the method is also able to pro vide a probability that the classification of a specific object is accurate.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a computer system embodying the present invention.

FIGS. 2a-2c are schematic illustrations of a preferred embodiment of the invention software executed in the computer system of FIG. 1.

FIGS. 3a-3b are significant feature charts output for the amino acid sequence in osteogenic proteins in the system of FIG. 1.

FIGS. 4a-4e are significant feature charts output for the amino acid sequence in osteogenic proteins in the system of FIG. 1.

FIG. 5 is the mathematical expectation value of a binary distribution given a small sample.

FIG. 6 is a plot of probability versus normalized score classifying osteogenic BMPs.

FIG. 7 is a plot of probability versus normalized score classifying osteogenic BMPs.

### DETAILED DESCRIPTION OF THE INVENTION

The present invention provides a method and apparatus for classifying objects given a collection or set of objects known to be similar to each other. In particular, the invention method and apparatus classifies polypeptides given a collection of known proteins (i.e., known to be similar to each other within the set).

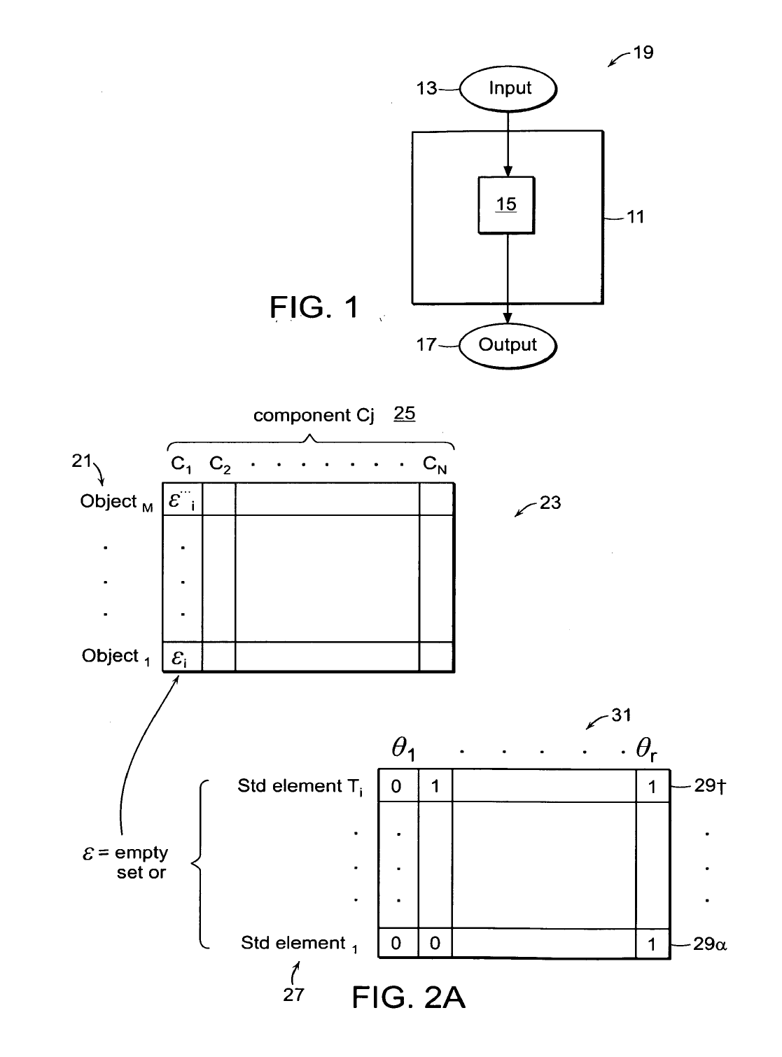

Illustrated in FIG. 1 is the present invention (software program 15) as implemented in a computer system 19. A digital processor 11 executes software program 15 in working memory. Software program 15 receives input 13 from another program, another computer (across a local network or through a communications link to an external network, e.g. the Internet), input device (mouse, keyboard, etc.) or the like. In response to the input, invention system 15 determines whether or not the input is a member of a predefined class. Output 17 from software program 15 is provided to another program, computer, database, or output device (e.g., display monitor) and/or the like.

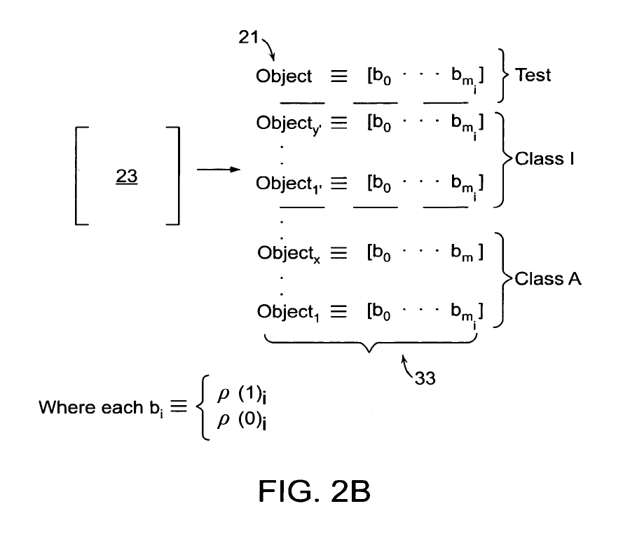

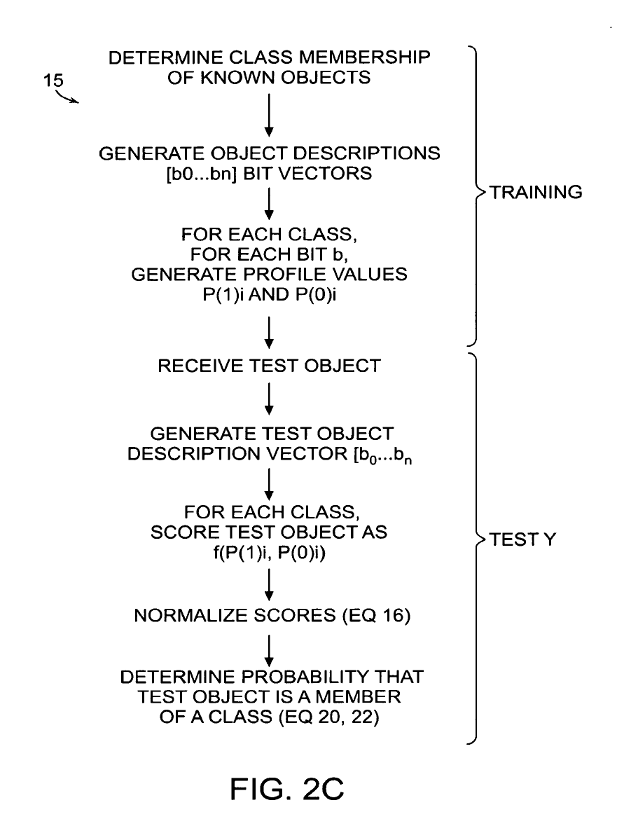

In the preferred embodiment, software program 15 is formulated as follows and illustrated in FIGS. 2a- 2c.

### The Core Paradigm

The method can be used with any system that fits the following core paradigm. Each object 21 within a collection of M similar objects comprises N components (C) 25 wherein there exists a unique correlation between component k in object i and component k in object j: Cᵢₖ˜Cⱼₖ. Thus a collection of M objects 21 can be represented as a matrix having M rows representing the M objects 21 and N columns representing the N components 25. Each cell in the matrix 23 is either empty or contains one of a set of elements 27 standard to that component 25. The elements 27 are represented as binary vectors 29 of features where each of the Qᵢ bits corresponds to a particular feature, a “1” indicating the presence of that feature and a “0” indicating the lack of that feature. Furthermore, it is required that objects 21 within the collection can be partitioned into three sets: one possessing a particular activity (the active training set), one lacking that activity (the inactive training set), and one where the activity is yet to be determined (the test set) as illustrated in FIG. 2b.

### Feature Vectors

Each of the standard elements 27 within a component 25 is represented by a set of Q features. An element either possess a particular feature or lacks it. Where the natural representation of a feature is a quantitative value, some cutoff value must be chosen below which the feature is judged to be absent (=0). The specific features chosen to represent elements 27 and the cutoff values determining the presence or absence of various feature must be chosen such that each of the standard set of elements 27 has a unique binary vector representation, i.e., such that within the standard element set for a component no two feature vectors 29 are equal. If there are Tᵢ standard elements in the i^{th} component, then a feature table 31 is a matrix of “1”s and “0”s having Tᵢ rows and Qᵢ columns, where row h is the feature vector for element h. The collection matrix can then be treated as an M×N matrix of 1's and 0's where the number of columns, N=Σ Qᵢ and where one significant row Tᵢ (feature vector 29) represents the I^{th} component 25. An object “descriptor” 33 is then a string of N bits as illustrated in FIG. 2b.

### Using Bayesian Log Odds to Construct Classification Profiles

Bayesian statistics deals with conditional probabilities and empirical logic. If set A is a subset of set B, then one can say that if an element is a member of set A it is also a member of set B, or that the probability that an element is a member of set B given that it is a member of set A, p(B|A), is 1. Suppose that set A is not a subset of set B, but only intersects B, i.e., p(B↑A)<1, and one wants to know what the probability is of an element being in both sets A and B, p(AB). If one knows the probability of an element being in A, p(A), and the probability of and element being in B given that it is in A, then

p(AB)=p(B|A) p(A)=p(A|B) p(B). (Eq. 1)

By the same reasoning, if one knows the probability of an element being in B, p(B), and the probability of and element being in A given that it is in B, p(A|B), then one can again calculate the probability of an element being in both sets. From Eq. 1, one can express one conditional probability in terms of the other:

p(A|B)=p(B|A) P(A)/ p(B). (Eq. 2)

Suppose there are three intersecting sets A, B and C. Then by the same line of reasoning

$$\begin{matrix}p ( AB \vert C ) = p ( A \vert BC ) p ( BC ) / p ( C ) \\ = p ( A \vert BC ) p ( B \vert C )\end{matrix}$$

which can be extended to four intersecting sets as

$$\begin{matrix}p ( ABCD ) = p ( ABC \vert D ) p ( D ) \\ = p ( AB \vert CD ) p ( C \vert D ) p ( D ) \\ = p ( A \vert BCD ) p ( B \vert CD ) p ( C \vert D ) p ( D )\end{matrix}$$

From this then follows the general chain rule for multiple sets,

$$\begin{matrix}p ( {b}_{1} … {b}_{n} \vert A ) = p ( {b}_{n} \vert {b}_{1} … {b}_{n - 1} , A ) \\ p ( {b}_{n - 1} \vert {b}_{1} … {b}_{n - 2} , A ) … p ( {b}_{1} \vert A ) \\ = \prod p ( {b}_{i} \vert {b}_{1} … {b}_{i - 1} , A ) , i = 1 \to N .\end{matrix} \qquad ( Eq . 3 )$$

If events b₁ and b₂ are independent, then the state of b₁ is not affected by the state of b₂ so that

p(b₁|b₂)=p(b₁).

Thus if the set of states {bᵢ} are all independent, then

p(b₁ . . . bₙ|A)=πp(bᵢ|A), i=1→N. (Eq. 4)

Two fundamental assumptions in this method are that the state of the i^{th} component 25 is independent of the state of the j^{th} component 25

p(Cᵢ|Cⱼ)=p(Cᵢ) (Eq. 5)

and that within a component, feature bits are also independent

p(bᵢⱼ|bⱼₖ)=p(bᵢⱼ). (Eq. 6)

What we are interested in here is the probability that an object 21 is active or inactive given the state of its description in bits, p(A|{bᵢ}) and p(I|{bᵢ}). What we know, however, are different descriptions of active and inactive objects 21. The data then allows as to evaluate p([bᵢ=1)|A), P([bᵢ=0)|A), P([bᵢ=1)|I) and p([bᵢ=0)|1). Bayes' rule says that

p(A|{bᵢ})=p({bᵢ}|A) p(A) p({bᵢ}), and

p(I|{bᵢ})=p({bᵢ}|I) p(I) p({bᵢ}).

By equation 4,

p({bᵢ}|A)=π p(bᵢ|A), i=1→N, and

p({bᵢ}|I)=π p(bᵢ|I), i=1→N.

Then

p(A|{bᵢ})=π p(bᵢ|A) p(A)/p({bᵢ}), and (Eq. 7a)

p(I|{bᵢ})=π p(bᵢ|I) p(I)/p({bᵢ}). (Eq. 7b)

The odds ratio is then

$$p ( A \vert \{ {b}_{i} \} ) = \prod p ( {b}_{i} \vert A ) p ( A ) / p ( \{ {b}_{i} \} ) \\ \begin{matrix}\overline{p ( I \vert \{ {b}_{i} \} )} = \overline{\prod p ( {b}_{i} \vert I ) p ( I ) / p ( \{ {b}_{i} \} )} \\ = [ p ( A ) / p ( I ) ] \prod [ p ( {b}_{i} \vert A ) / p ( {b}_{i} \vert I ) ] .\end{matrix} \qquad ( Eq . 8 )$$

It is preferable to express profile values as log odds ratios, in part because it is easier to express very small numbers as logs, and because scores can be accumulated as sums rather than products. There are two terms for each bit in the profile:

LO(1)ᵢ=log [p(bᵢ=1|A)/p(bᵢ=1|I)], and (Eq. 9A)

LO(0)ᵢ=log [p(b₁=0|A)/p(bᵢ=0|I)] (Eq. 9B)

A profile is then the set of paired values

P(1)ᵢ=p([bᵢ=1]|A)*LO(1) and

P(0)ᵢ=p([bᵢ=0]|A)*LO(0)

for each bit in the object description 33. The two major advantages of using the odds ratio to construct the profile are that first, it is based on the contrast between the active and inactive classes, and second, one does not have to deal with the prior distribution of the bits, p({bᵢ}). Multiplying the log odds by the respective active probability orders the values such that feature conservation within the active class is enhanced.
Estimating Population Distributions from Small Samples

Although an unbiased estimator, the sample mean is generally not a good estimate of the population distribution, especially in the limit of small samples. If five white balls are selected from a vase containing some unknown distribution of 1000 black and white balls, it would be unreasonable to postulate that based on the draw of 5 white balls there are no black balls in the vase because the observed sample is so small relative to the size of the population. Furthermore, probability estimates of zero are a major problem in calculations such as that in equations 7 and 8 because one zero probability sends the entire expression to zero. Put another way, while it is reasonable to have small probabilities, it is unreasonable to have zero probabilities. What we want to know is given the sample, what is the expectation value of the population distribution? Given any value for the population distribution one can calculate the probability of observing the sample

p(w,b)=[(w+b)!/w!/b!]p₀^{w} (1−p₀)^{b}, (Eq. 10)

where p0 is the population distribution of white balls. The expectation value for p₀ given the observed sample is then

$$E ( {p}_{0} \vert w , b ) = \frac{{\int }_{0}^{1} {p}_{0} [ ( w + b ) ! / w ! b ! ] {{p}_{0}^{w} ( 1 - {p}_{0} )}^{b} d {p}_{0}}{{\int }_{0}^{1} [ ( w + b ) ! / w ! b ! ] {{p}_{0}^{w} ( 1 - {p}_{0} )}^{b} d {p}_{0}} \qquad ( Eq . 11 )$$

This expression is worked out in FIG. 1) with the result that

E(p₀|w,b)=(w+1)/(w+÷b+2). (Eq. 12)

Thus for the sample of five white balls, E(p₀)=6/7.

In order to calculate odds ratios for 1's and 0's at each bit in the profile, it is then necessary to estimate the population frequency of 1's and 0's at that bit. By equation 10

p₀(A,bᵢⱼ=1)=(n_{A}(1)(i,j)+1)/(N_{A}+2), and (Eq. 13A)

p₀(I,bᵢⱼ=1)=(n_{I}(1)(i,j)+1)/(N_{I}+2) (Eq. 13B)

where b_{i,j} is the j^{th} bit for the element vector for the i^{th} component, n_{A}(1)(i,j) and n_{I}(1)(i,j) are the number of 1's at bit j of component i in the active and inactive sets, respectively, and N_{A} and N_{I} are the number of objects, respectively, in the active and inactive sets.

One of the major advantages of using binary vector representations of component elements is that estimation is simplified because the alphabet size is 2. If one were to estimate population frequencies from the observed frequency of the component elements themselves, the likelihood is that the alphabet size, the number of elements in the standard set for the component, would exceed the number of objects in the training set. If there are N_{A} objects in the active training set and no; elements in the standard set for component i, then at least (nᵢ−N_{A}) elements are unsampled. The problem of estimating the population frequency of unsampled elements is a nontrival problem which is circumvented by the use of binary representation.

The foregoing completes the training phase (FIG. IIc) of invention software 15. Referring now to the lower portion of FIG. IIc, the testing phase of the invention software 15 is shown and described next.

### Using the Profile to Score a Test Object

The raw score of a test object for a particular profile is the sum of the bitwise score:

$$S = log ( p ( A ) / p ( I ) ) + {\sum }_{k = 1}^{N} {S}_{k} \qquad ( Eq . 14 )$$

where

$${k}_{ij} = j + {\sum }_{h = 1}^{i - 1} {Q}_{h}$$

indexes bits. The bitwise score

Sₖ=bₖ P(1)ₖ÷(1−bₖ) P(0)ₖ (Eq. 14)

where bₖ is the value of the k^{th} bit.

### Maximum and Minimum Profile Scores

Given a standard set of elements for each component there exists a maximum and a minimum possible score for that component. Likewise, then, since the raw score for a profile is the sum of the components scores, there exists a maximum raw score (maxscore) and a minimum raw score (minscore) for a profile, the sums of the maximum and minimum bit scores, respectively.

Normalized Scores (nscore)

The maximum and minimum scores for a profile can vary considerably depending, upon the constitution of the active and inactive sets. Similarly, the raw score of a test object for a profile can vary greatly depending upon the constitution of the training sets. Much of this variation is eliminated by expressing scores as normalized scores, referred to below as nscores. For the k^{th} test object scored against the i^{th} profile the nscore is

nscore(j,k)=[raw score(j,k)−minscore(j)]/[maxscore(j)−minscore(j)]. (Eq. 16)

The nscore has a value between zero and one.

### Unbiased Scores and Variability Analysis

Any time a training object is scored against a profile trained on that object, a biased score will result. In order to obtain a score for a training object, a profile is constructed in which that object is left out of the training set, the so called “leave-one-out” method. When training sets are small, one of the best ways to evaluate the accuracy of a profile is to use the “leave-one-out” method. In particular, one can create M=N_{A}±N_{I} partial profiles by leaving out each member of the active and inactive training sets one at a time. For each bit there will then exist M values of P(1)ᵢ and of P(0)ᵢ. These two distributions of M values will each have a mean, and a standard error of the mean. The percent standard error of the mean for P(1) and P(0) (the standard error of the mean divided by the mean) can be used to calculate the error in the raw score when a test object is scored against the complete profile. The percent error E in the raw score is

$${f}_{Err} = {\sum }_{k = 1}^{M} {b}_{k} {E}_{k} ( 1 ) + ( 1 - {b}_{k} ) {E}_{k} ( 0 ) \qquad ( Eq . 17 )$$

where bₖ is the k^{th} bit in the test sequence.

### Building a Classifier

By scoring a left-out member of a training set against the partial profile constructed using its peers, one can generate an “active” distribution of N_{A} active nscores and an “inactive” distribution of N₁ inactive nscores. These distributions are of great utility in classifying test objects. A classifier is a function that, given an nscore for a test object, generates a value (binary or a probability) that classifies the object as either active or inactive. The active and inactive nscore distributions can be used both to assess the classification quality of the profile and to generate a probability-of-being-active for test objects. The standard statistical method of Student's t-test (one tailed, non-paired, unequal variance) can be used to obtain a probability that the active and inactive distributions are the same, the null hypothesis. To be a good classifier, the active and inactive training scores must form distinct distributions. The value

p(Good Classifier)=(1−p(null))

should be 0.9 or better if the discriminating ability of a particular profile is sufficient to function as an effective classifier.

Another common method for assessing classifier accuracy is the area under the “Receiver Operating Characteristic” (ROC) curve. A ROC curve is constructed by plotting, for each nscore value, the frequency of true-positive classifications against the frequency of false-positive classifications. Classifier accuracy can be defined as

α=½ (ROC area−½). (Eq. 18)

A value of α>0.9 is good. To construct a theoretical ROC curve it is necessary to calculate the probability of true-positive (tp) and false-positive (fp) classifications as a function of nscore:

p(tp|nscore>=X)=(1/σ_{A} \sqrt{2π}) ∫_{X}^{+∞}e⁻(x−μ_{A}/2σ_{A})^{:}dx. (Eq. 19A).

Similarly, the probability of a false-positive (fp) classification as a function of nscore is

p(fp|nscore>=X)=(1/σ₁ \sqrt{2π}) ∫_{X}^{÷∞}e⁻(x−μᵢ/2σᵢ)^{:}dx. (Eq. 19B)

The area under the ROC curve can then be obtained by numerical integration.

### Classifying Test Objects

There are two approaches to generating a classification probability for a test object. The first and likely most accurate method is to score a test object against each of the M partial profiles in order to generate a distribution of nscores for the test object that is similar to the nscore distributions for the active and inactive sets. The t-test (i.e., single tail, two sample, independent variable) can be used to calculate the probabilities that the test object distribution is identical to the active and to the inactive distributions, respectively. The classification probability is then

p_{Active} (TestObject)=p˜(TestDist, ActiveDist)/(p_{Null} (TestDist,ActiveDist)+p_{Null} (TestDist, InactiveD [symbol] (Eq. 20)

An alternative method that is less computationally intensive involves constructing a classification curve as the ratio. Let

p_{A} (nscore)=(1/σ_{A} \sqrt{2π})∫_{∝}^{nscore} e⁻(x−μ_{A}/2σ_{A})²dx (Eq. 21A)

p_{I}(nscore)=)1/σ_{I} ·\sqrt{2π})∫_{nscore}^{∝}e⁻(x−μ_{I}/2σ_{I})²dx (Eq. 21B)

p_{Active} (nscore)p_{A}(nscore)/(p_{A}(nscore)+p_{I} (nscore)) (Eq. 22)

To classify a test object, it is first scored once against the complete profile (none of the training set left out) to obtain an nscore value and then p_{Active}(nscore) is calculated from the curve given by eq. 22.

While method 2 is likely less accurate than method 1 in its prediction of p_{Active} for objects that score in the transition region of the classification curve, it is generally much faster to implement than method 1. The preferred procedure when there is a large number of objects to classify is to use method 2 as an initial filter, and to reclassify those objects for which 0.05<p_{Active}<0.95 using method 1.

### Estimation of Classification Error

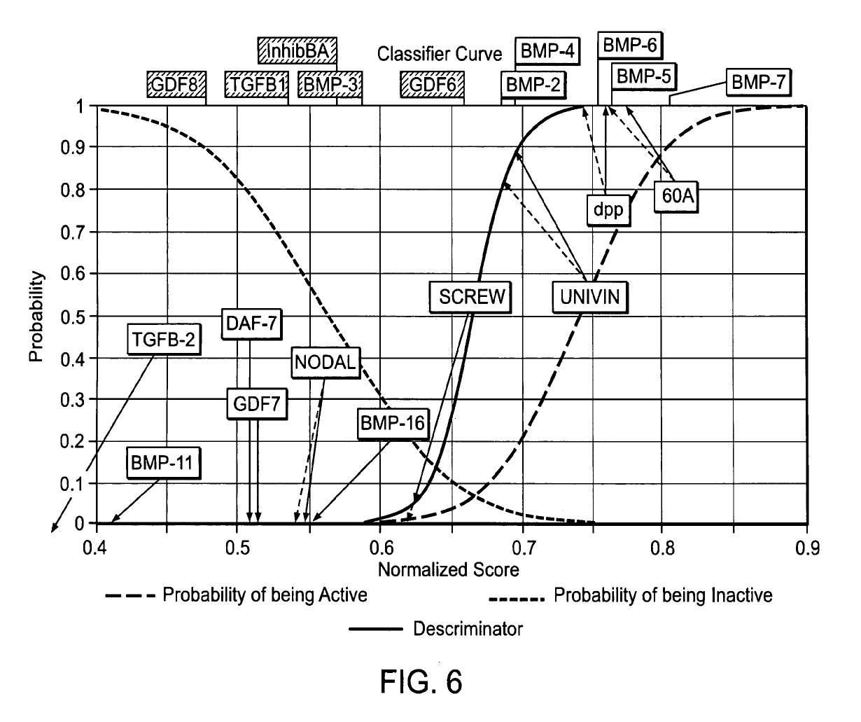

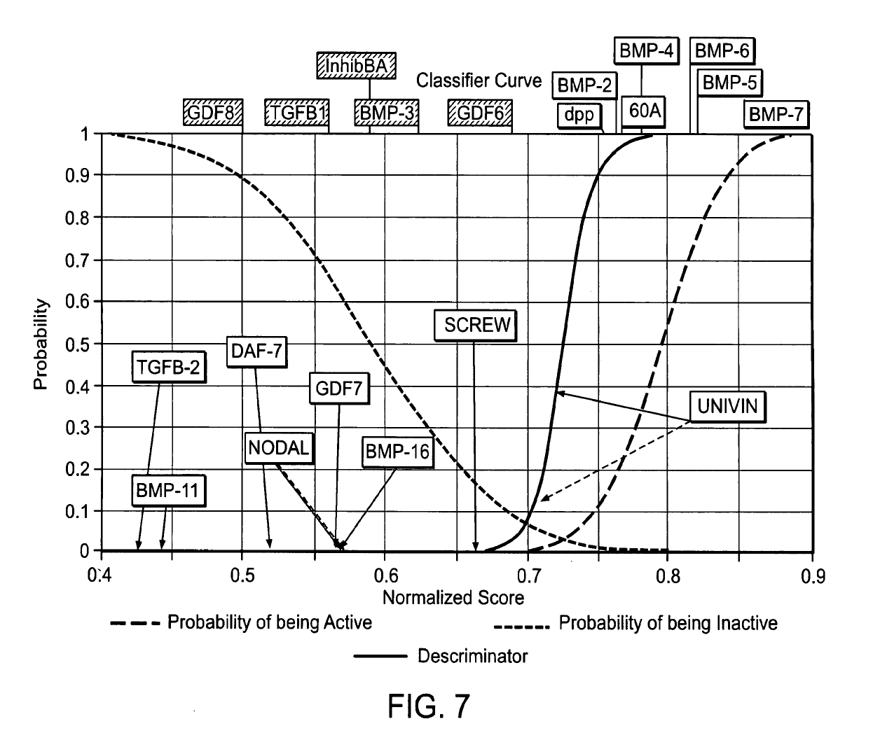

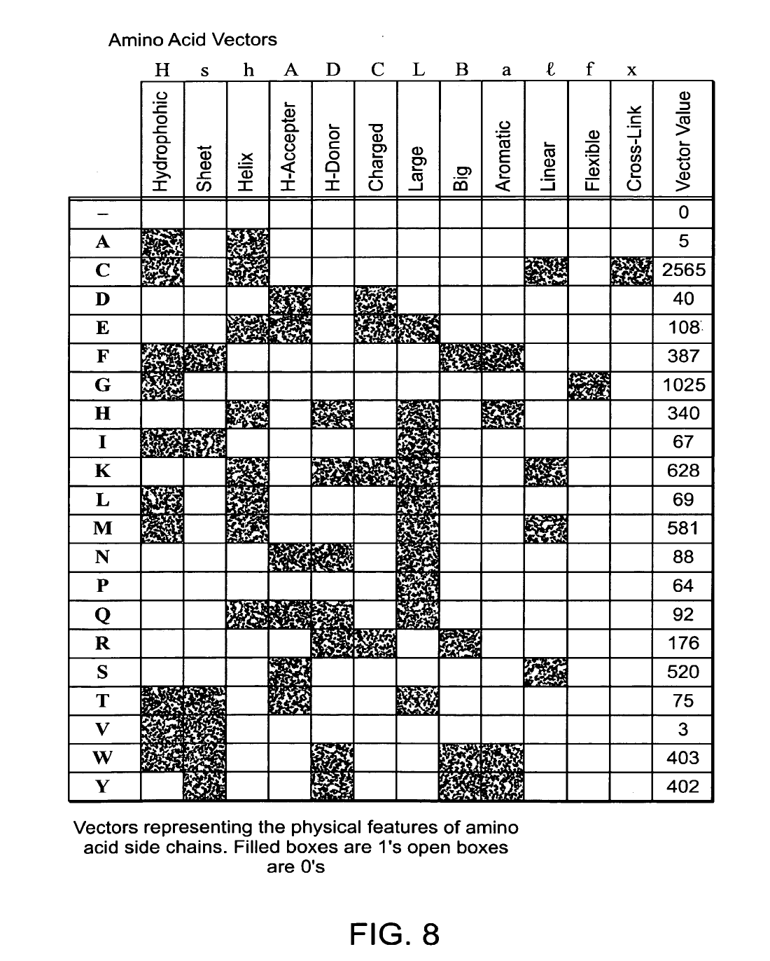

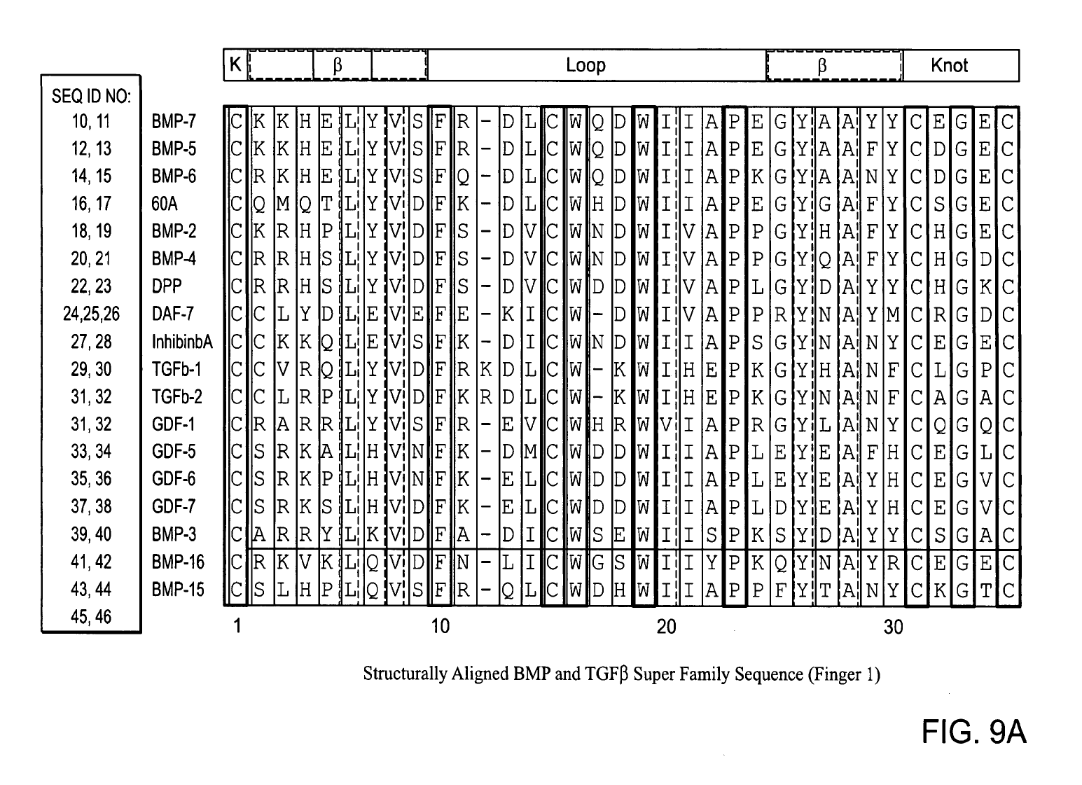

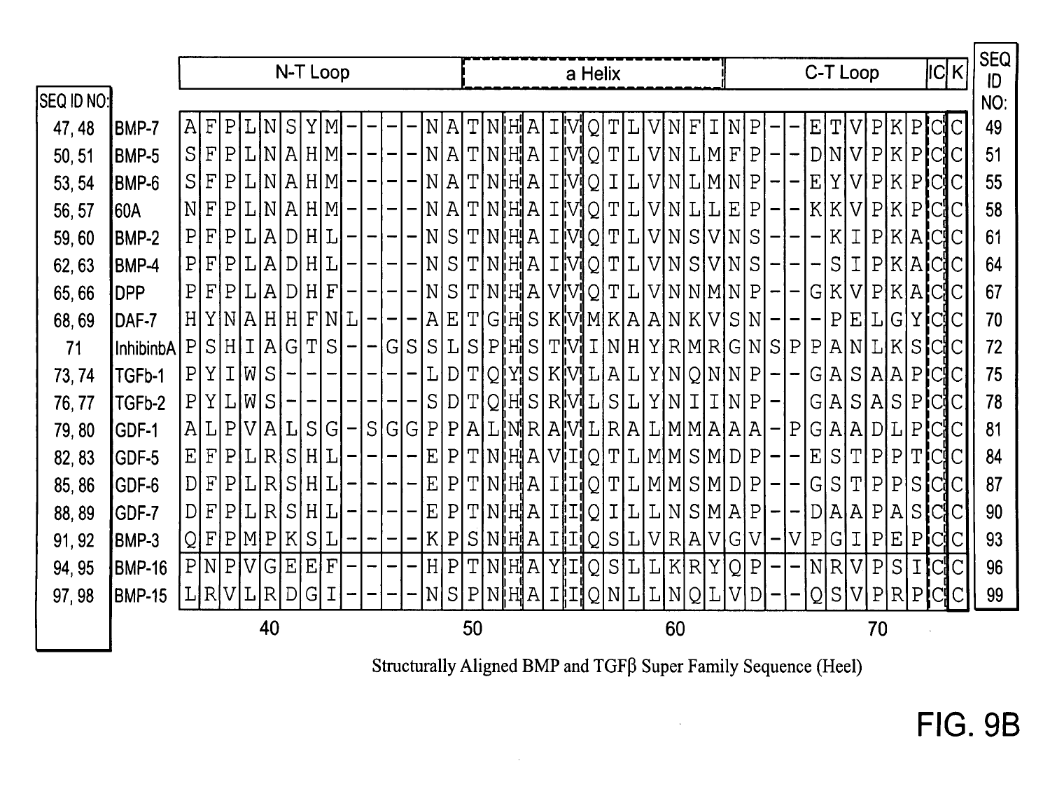

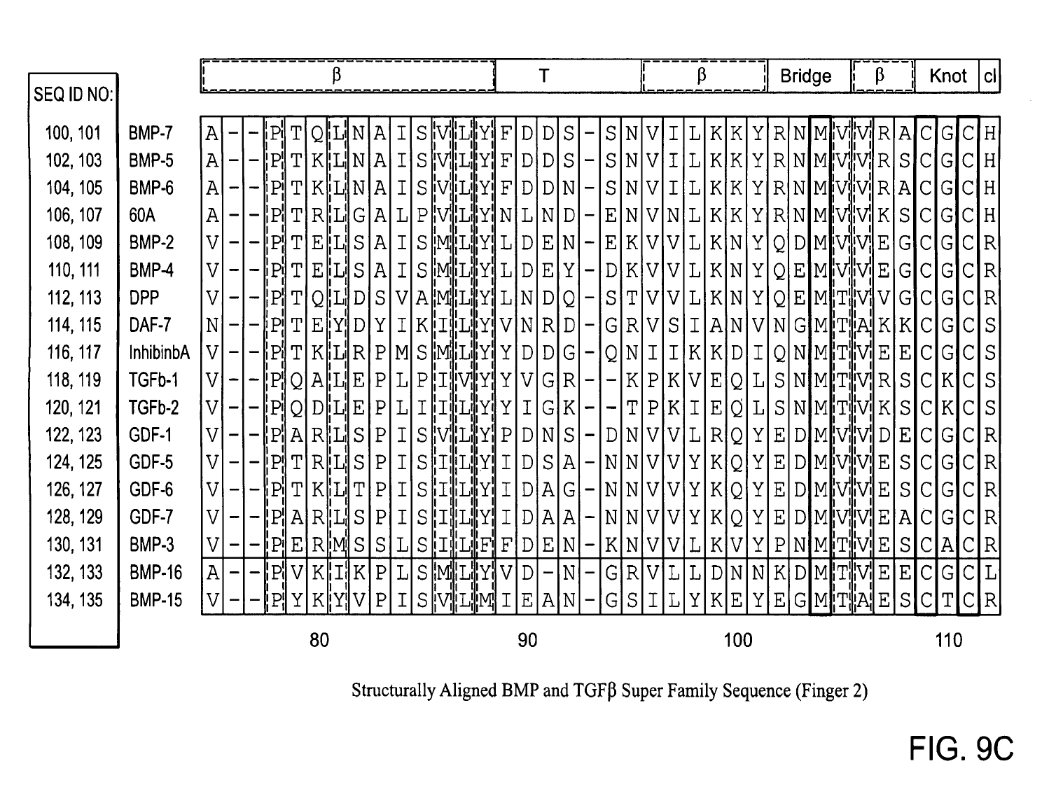

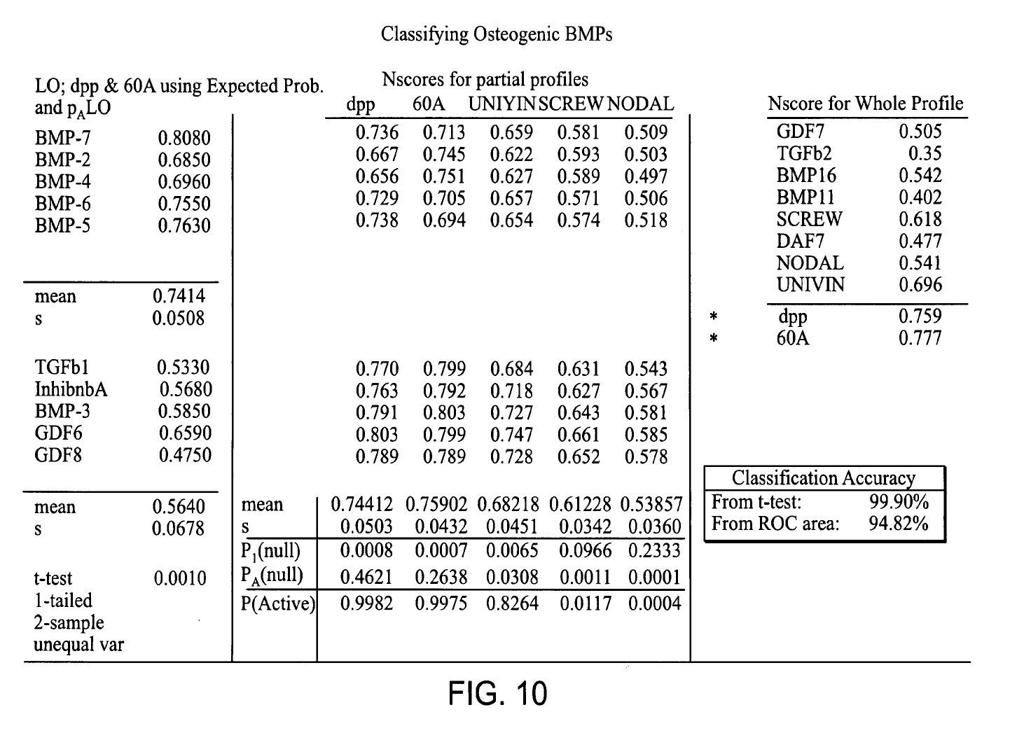

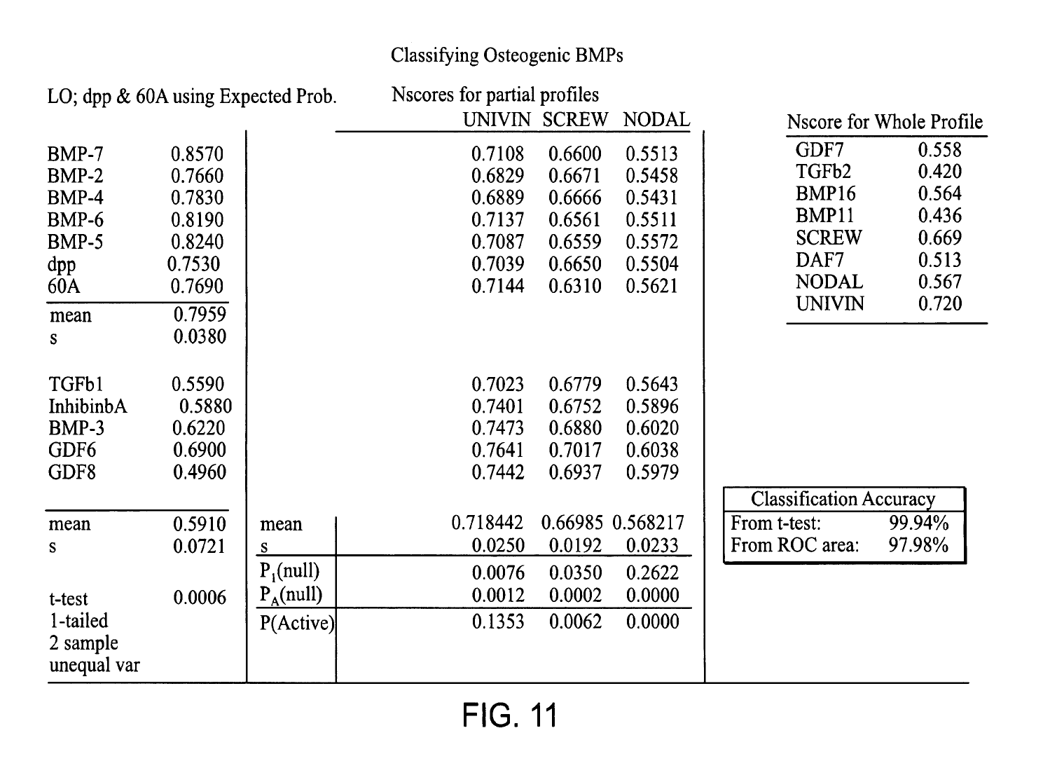

In classification method 2, the uncertainty in the value of p_{Active} equals uncertainty in the nscore value times the absolute value of the slope of the classification curve. Thus the values of p_{Active} are least accurate in the region of intermediate classification. Uncertainty in the nscore value has two origins. First, there is uncertainty in the horizontal position of the classification curve because there is a finite error of the mean of both the active and the inactive distributions, and secondly, there is uncertainty in the nscore value for the test object as discussed above. If the active and inactive distributions are well separated (i.e., the profile accuracy Figure is greater than 0.9) then the transition region of the classification curve will be narrow and steep so that not far either side of this region the classification curve will have a zero slope and the error in p_{Active} will vanish regardless of the size of the nscore errors (FIGS. 6 and 7).

### Identification of Activity Correlated Features

Informational relative entropy is a measure of the information contained in the difference between two distributions. As such, it can also be considered to be a measure of informational significance. For a binary distribution the relative entropy is given as

H(p|q)=p₀ log[p₀/q₀]÷p₁ log [p₁/q₁] (Eq. 23)

where q is the reference distribution, p₁ p₀=1, and q₁+q₀=1. In the present method, distribution p is the distribution of 1's for a bit in the active set and q is the distribution of 1's for that bit in the inactive set. We therefore define the bitwise significance as

sᵢⱼ=p_{A}(1)ᵢⱼ LO(1)ᵢⱼ p_{A}(0)ᵢᵢ LO(0)ᵢⱼ (Eq. 24)

where ij indexes the j^{th} bit of the i^{th} component in the respective sets, and LO(1) and LO(0) are the log odds ratios of eq. 10. In order to determine which features in which components contribute most the classification characteristics of a profile, one need only to look at those features having the largest significance.

Another embodiment of the present invention is a cyclic polypeptide that can modulate the activity of bone morphogenetic proteins (BMP), particularly, bone morphogenetic protein-7 (BMP) (inhibit or enhance). The cyclic polypeptide is homologous to the Finger 1, Finger 2 or Heel region of bone morphogenetic protein-7, which have the following amino acid sequences: SEQ ID NO. 1, KKHELYVSFRDLGWQDWIIAPEGYAAYY (Finger 1); SEQ ID NO. 2, AFPLNSYMNATNI-LkIVQTLVHFINPETVPICP (Heel); and SEQ ID NO: 3 APTQLNAISVLYFDDSSNVILKKYRNMVVRACGC (Finger 2).

“Homologous” means that the cyclic polypeptide has the amino acid sequence of SEQ ID NOS. 1, 2 or 3 or a fragment thereof having at least 5, typically at least 10, more typically at least 11 and often at least 15 amino acids, provided that the polypeptide can have 1, 2, 3, 4 or 5 amino acids which differ from the wild type. The polypeptides modulate bone morphogenetic protein-7 activity. Polypeptides having the amino acid sequence of SEQ ID NOS. 4-9 are specifically excluded. Preferably, the polypeptides of the present invention are homologous to polypeptides having the amino acid sequence of SEQ ID NOS 4-9, with the aforesaid exclusion. Preferably, the polypeptides are cyclized by replacing two amino acids from the wild type sequence with cysteine and then forming a disulfide bond (e.g., a solution of 25 mg of iodine in 5 mL, of 80% aqueous acetic acid with 5 mg of peptide, preferably with protected side chain functional groups).

| | |
|---|---|
| F1-1 | (5′ CELYVSFRDLGWQDWIIAPEGYAAYC, SEQ ID NO. 4) |
| F1-2 | (CFRDLGWQDWIIAPC, SEQ ID NO. 5) |
| H-1 | (CAFPLNSYMNATNHAIVQTLVHFINPETVPKC, |
| | SEQ ID NO. 6) |
| H-2C | (CCFINPETVCC, SEQ ID NO. 7) |
| F2-2 | (CYFDDSSNVIC, SEQ ID NO. 8) |
| F2-3 | (CYFDDSSNVICKKYRS, SEQ ID NO. 9) |

The bold indicates these cysteines residues are connected by a disulfide bond.

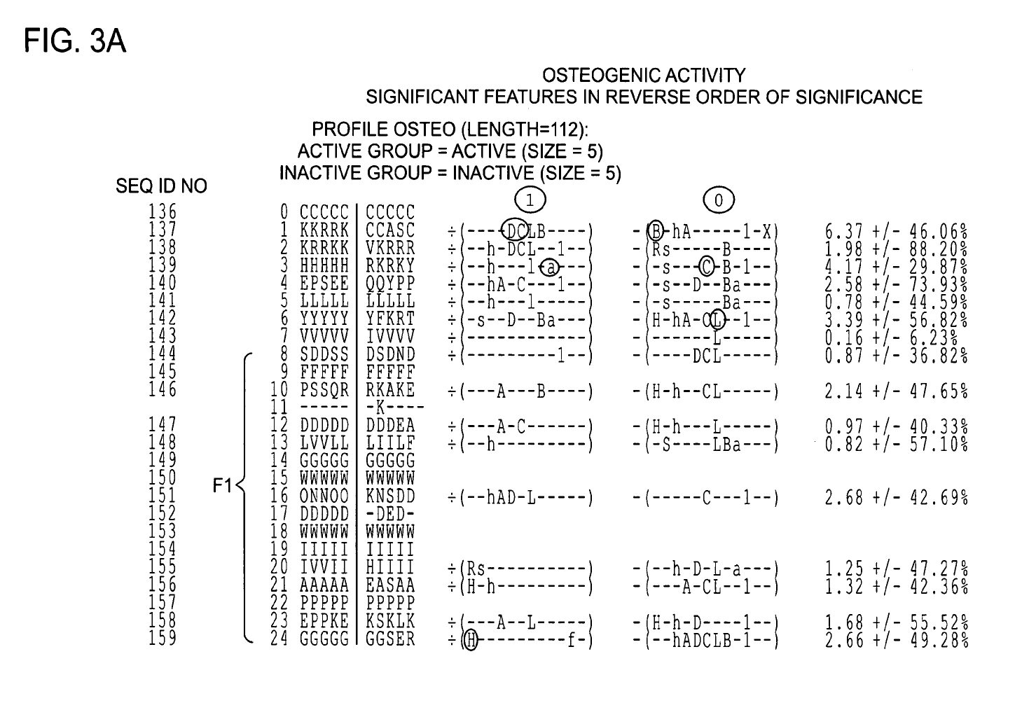

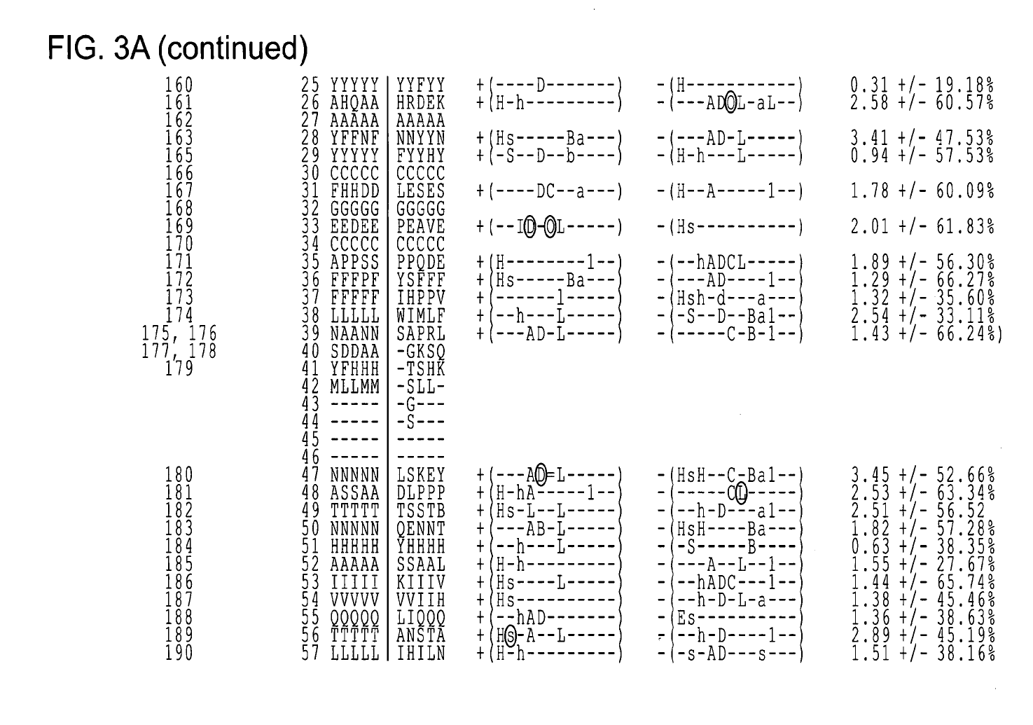

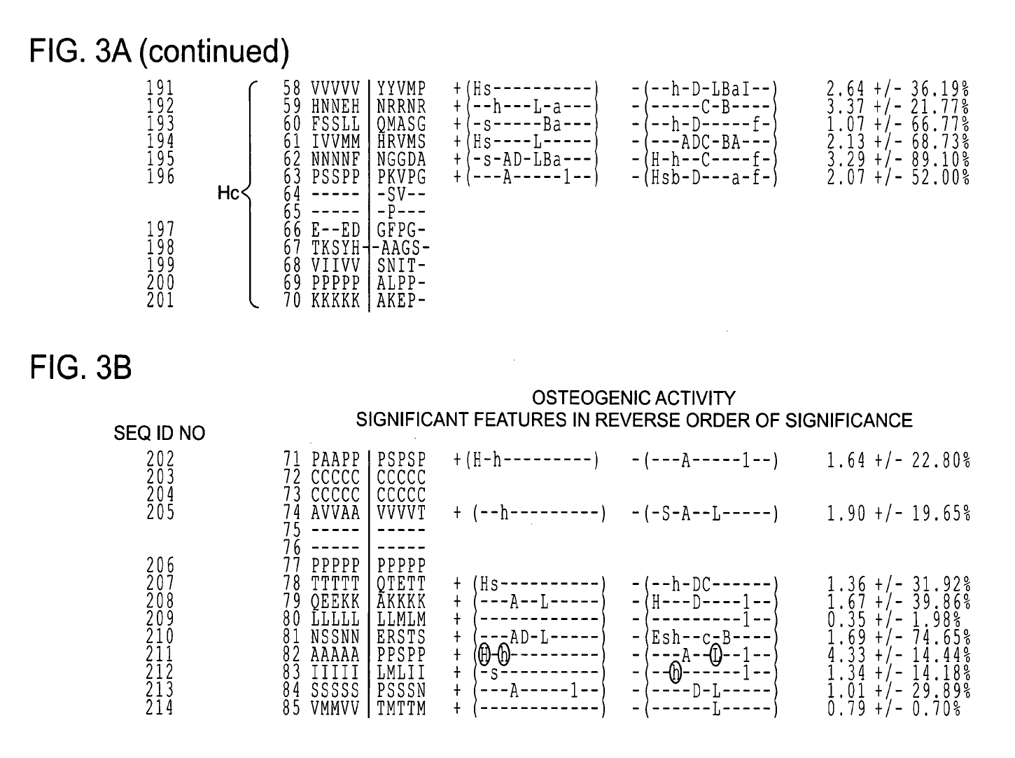

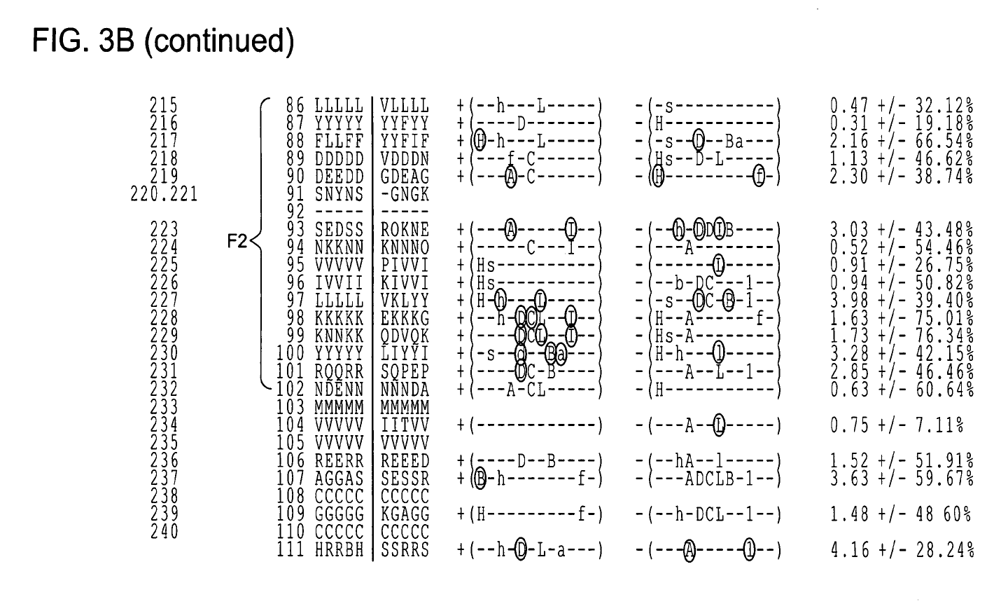

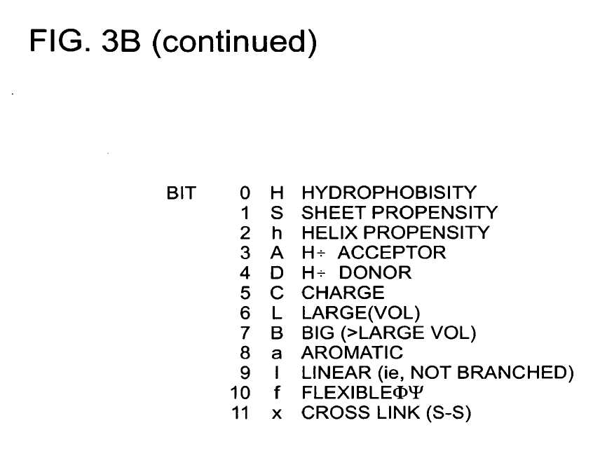

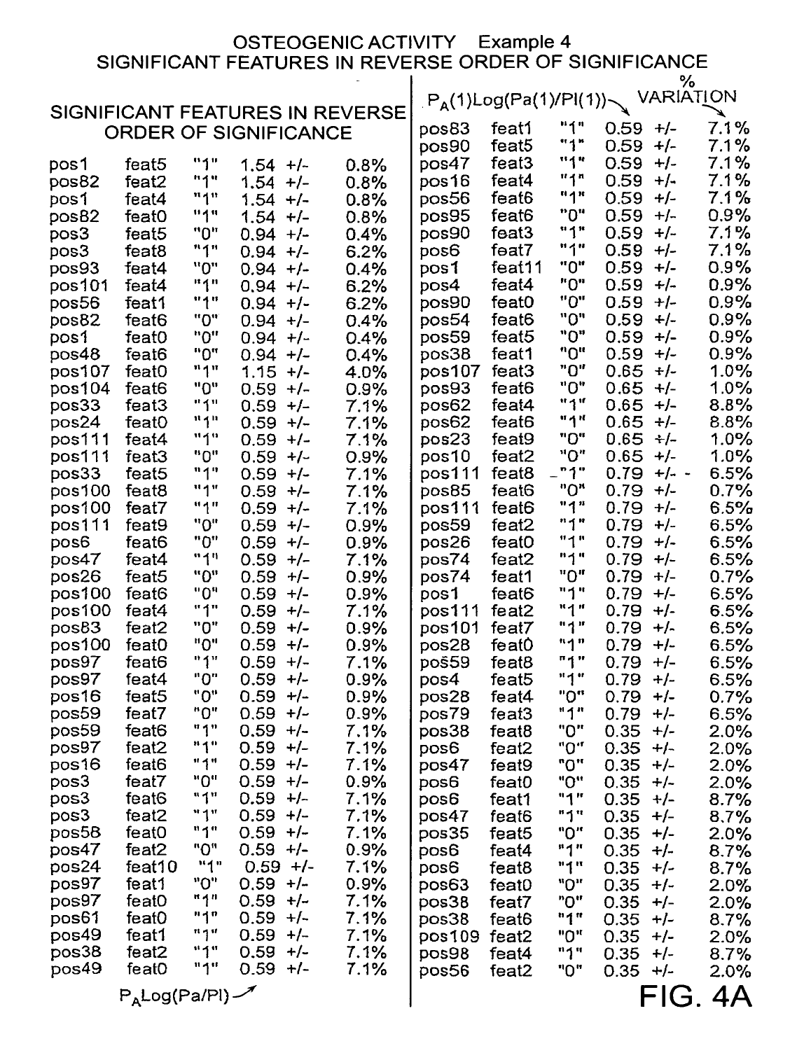

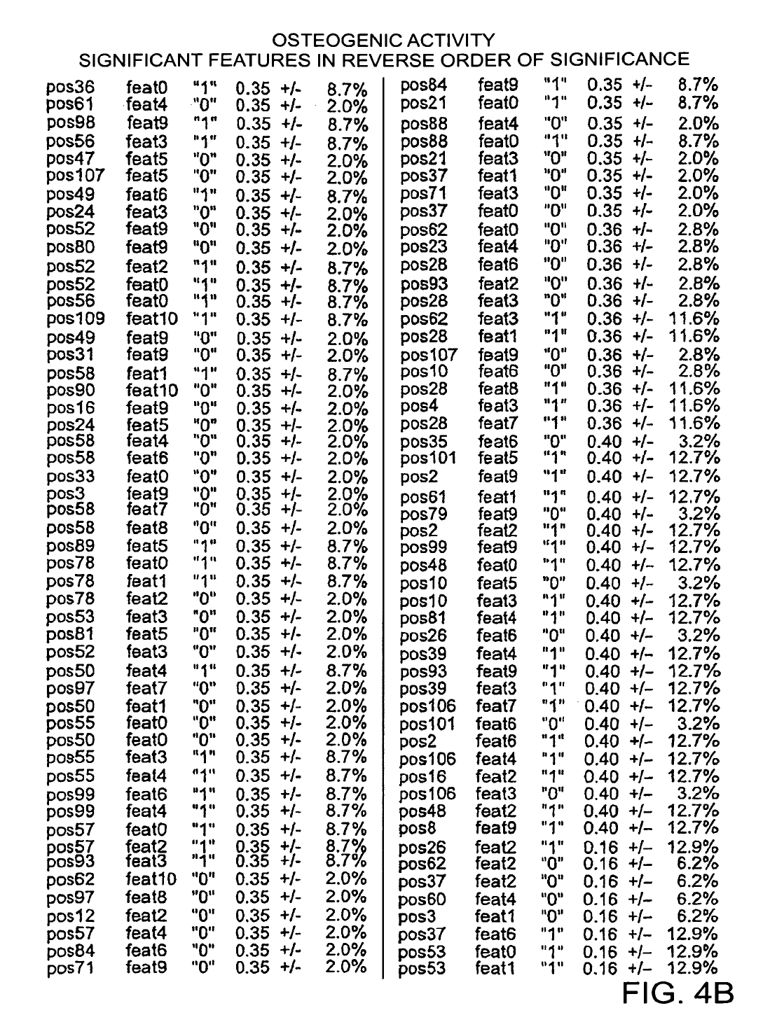

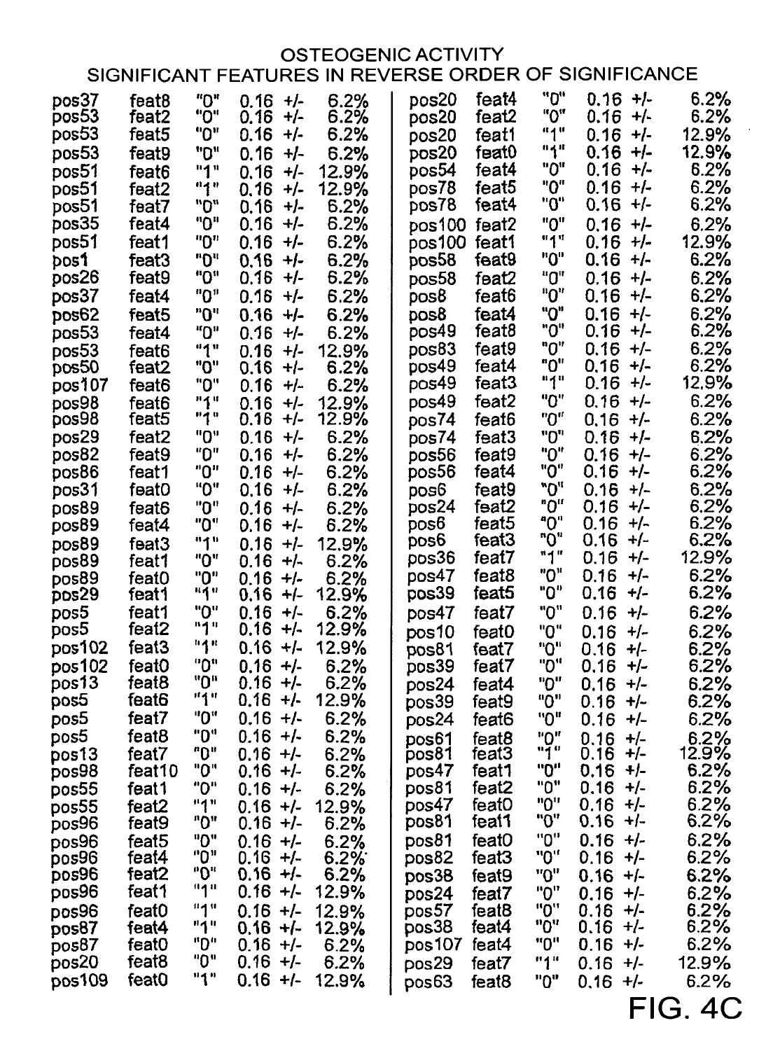

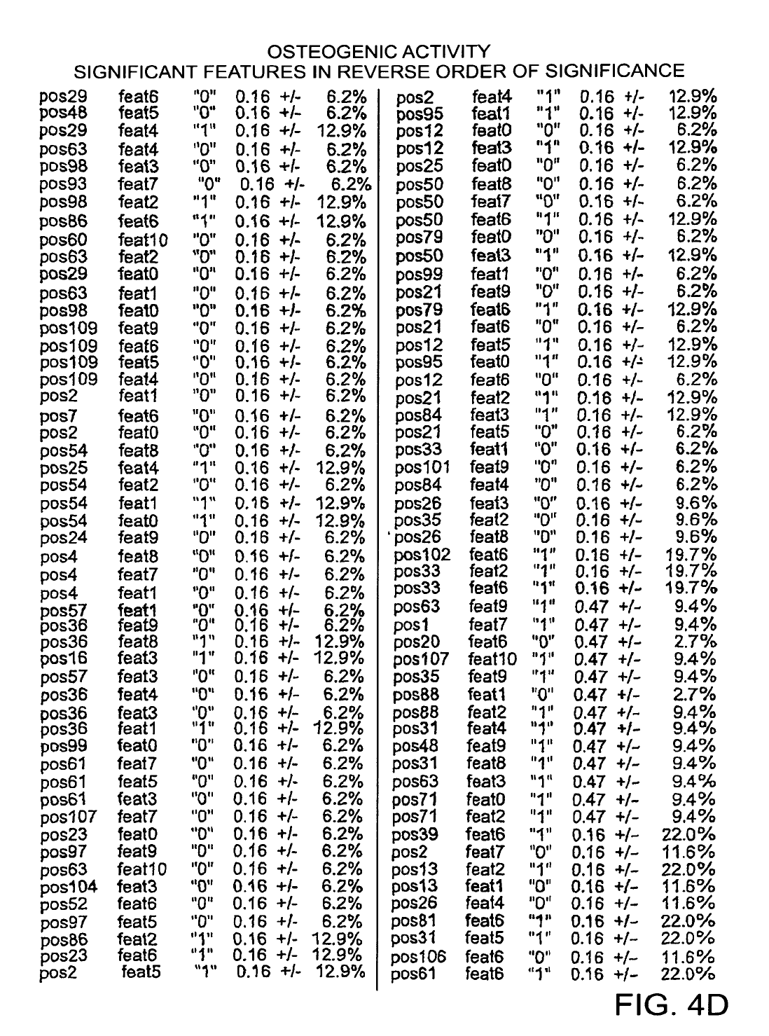

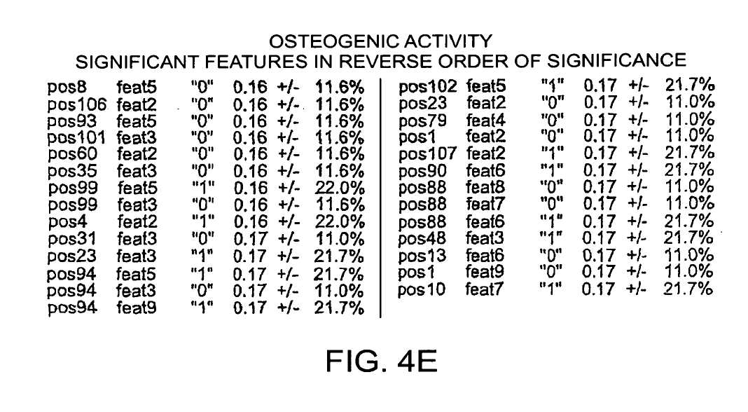

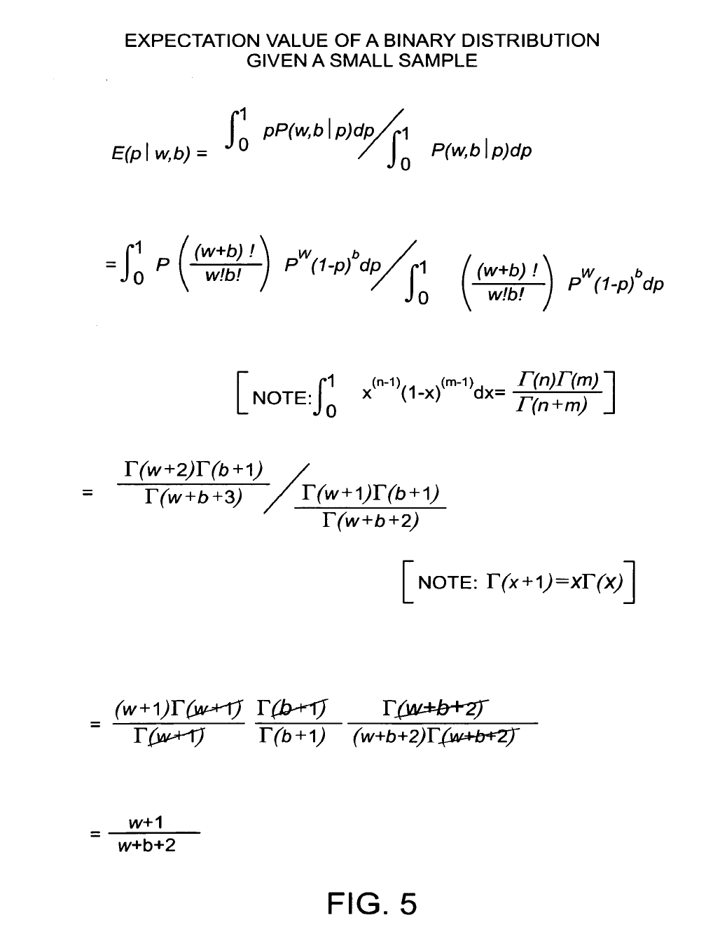

Suitable amino acid substitutions in Finger 1, Finger 2 and the Heel regions are determined by the computational methods described hereinabove. In particular, apply significance equation 24 to each bit of each amino acid feature vector in each protein. Take the top most significant bits of each feature vector of the amino acids in these three regions and correlate those to the features (physical properties) represented by the respective bit. Examples of the significant features ordering and corresponding features per bit are illustrated in FIGS. 3a, 3b and 4a-4e.

Physiologically acceptable salts of the polypeptides are also included.

Another embodiment of the present invention is a method of treating a subject in need of treatment which modulates (inhibits or enhances) the activity of BMP. An effective amount of the polypeptide is administered to the subject.

Polypeptides which inhibit the activity of BMP can be used to treat subjects in whom a reduction of BMP-7 activity can provide a useful therapeutic effect. Examples include pituitary abnormalities and other endocrinopathies. Also included are subjects in need of treatment with angiogenesis inhibitors (e.g., patients with cancer), with agents that reduce arteriosclerosis, and agents which prevent restenosis (e.g., patients following angioplasty).

Polypeptides which enhance the activity of BMP-7 can be used to stimulate the formation of new bone and could therefore be used to treat osteoporosis. These compounds can also enhance the functional remodeling of remaining neural tissues following neural ischemia such as stroke when used within a therapeutic time window, or to promote recovery of drug induced ischemia in the kidney and the effects of protein overload, or to ameliorate the effects of acute myocardial ischemic injury and reperfusion injury. They may be also useful in the treatment of certain types of cancer, e.g., prostate cancer and pituitary adenomas, and ameliorating the effects of chemically induced inflammatory lesion in the colon.

An “effective amount” of the peptides of the present invention is the quantity of peptide which results in a desired therapeutic and/or prophylactic effect while without causing unacceptable side-effects when administered to a subject having one of the aforementioned diseases or conditions. A “desired therapeutic effect” includes one or more of the following: 1) an amelioration of the symptom(s) associated with the disease or condition; 2) a delay in the onset of symptoms associated with the disease or condition; 3) increased longevity compared with the absence of the treatment; and 4) greater quality of life compared with the absence of the treatment.

An “effective amount” of the peptide administered to a subject will also depend on the type and severity of the disease and on the characteristics of the subject, such as general health, aae, sex, body weight and tolerance to drugs. The skilled artisan will be able to determine appropriate dosages depending on these and other factors. Typically, an effective amount of a peptide of the invention can range from about 0.01 mg per day to about 1000 mg per day for an adult. Preferably, the dosage ranges from about 0.1 mg per day to about 100 mg per day, more preferably from about 1.0 mg/day to about 10 mg/day.

The peptides of the present invention can, for example, be administered orally, by nasal administration, inhalation or parenterally. Parenteral administration can include, for example, systemic administration, such as by intramuscular, intravenous, subcutaneous, or intraperitoneal injection. The peptides can be administered to the subject in conjunction with an acceptable pharmaceutical carrier, diluent or excipient as part of a pharmaceutical composition for treating the diseases discussed above. Suitable pharmaceutical carriers may contain inert ingredients which do not interact with the peptide or peptide derivative. Standard pharmaceutical formulation techniques may be employed such as those described in Remington's Pharmaceutical Sciences, Mack Publishing Company, Easton, Pa.

Suitable pharmaceutical carriers for parenteral administration include, for example, sterile water, physiological saline, bacteriostatic saline (saline containing about 0.9% mg/ml benzyl alcohol), phosphate-buffered saline, Hank's solution, Ringer's-lactate and the like. Some examples of suitable excipients include lactose, dextrose, sucrose, trehalose, sorbitol, and mannitol.

A “subject” is a mammal, preferably a human, but can also be an animal, e.g., domestic animals (e.g., dogs, cats, and the like), farm animals (e.g., cows, sheep, pigs, horses, and the like) and laboratory animals (e.g., rats, mice, guinea pigs, and the like).

### EXAMPLE 1

### Classification of Protein Sequences by Activity

The following analogy is made between the central paradigm of the classification method and the case of protein sequences. Protein sequences are objects. A set of sequences similar enough to be aligned as a super family constitutes a collection. The aligned sequence positions are components. In this case all components have the same standard set of elements which is the 20 naturally occurring amino acids and so have the same vector width, Q. A binary vector scheme of width Q=12 is shown in Table 1. The 12 features making up the feature set are: hydrophobicity, helix propensity, sheet propensity, hydrogen donor propensity, hydrogen acceptor propensity, the state of being charged, aromaticity, sidechain linearity (unbranched), medium sidechain volume, large sidechain volume, Phi-Psi flexibility and crosslinkability (disulfide bond formation). The central paradigm requires that one assume that aligned sequence positions are independent and that features are independent.

### EXAMPLE 2

### Classification of Osteogenic Seauences in the TGFβ Protein Super Family-I

Table 2 is an aligned set of TGFβ super family sequences. Those with a plus sign next to them are known to be able to stimulate the formation of ectopic bone, while those with a minus sign next to them are known to be unable to form ectopic bone. In this example the active set includes BMP7, BMP6, BMPS, BMP4 and BMP2. Dpp. and 60A, both known osteogenic proteins from drosophila melogaster, are reserved for test purposes. The inactive set includes sequences for TGFβ1, BMPS, GDF8, Inhibin⊕A and GDF6. The results are presented in Table 3 and FIG. 2. The classifier is good, having and accuracy figure of 99.9% by the t-test and 94.8% by the ROC curve area.

Using either classification methods 1 or 2, the classifier correctly identifies dpp and 60A as being osteogenic with a probability greater than 99% despite the fact that their origin is an insect which has a chitin exoskeleton and no bones. Within the test set, the only other protein predicted to be a possible osteogenic molecule is UNIVIN with an osteogenic probability of 83% (method 1) and 89% (method 2).

### EXAMPLE 3

### Classification of Osteogenic Sequences in the TGF⊕ Protein Super Family-II

In this example, dpp and 60A have been added to the active training set used in example 2. The inactive set is the same as that for example 2. The results are presented in Table 4 and FIG. 7. The classifier accuracy figures of 99.94% (t-test) and 98% (ROC curve area) are improved with the addition of dpp and 60A. UNIVIN still scores in the classification transition area with a p_{Active of} 13.5% (method 1) and 39% (method 2).

The effect of adding dpp and 60A to the active training set is to shift the transition zone (0.1<p_{Active}<0.9) to higher values of nscore(p_{Active}=50% occurs at an nscore of 0.67 in example 1 and at 0.695 in this example) and to narrow the zone (0.07 in example 2 versus 0.05 in this example). Thus, even though the nscore values for LTNIVIN are higher in this example (0.718 versus 0.682 in Example 2 using method 1, and 0.720 versus 0.696 in Example 2 using method 1), it actually scores lower (13% using method 1 and 39% using method 2). Despite the fact that it is less likely to be an osteogenic protein, the classifier still identifies it as the most interesting member of the test set to pursue research on

### EXAMPLE 4

Identification of those Features and Residue Positions Having the Largest Significance for Osteogenicity

In this example, the structure of the complete profile created in example 3 is examined to identify those features that are correlated or are anti-correlated with osteogenic activity. There are two properties of interest. First is the relative entropy of a feature where the higher the relative entropy the larger the significance, and second is the percent variation associated with the positive P value at each bit. The significance of a bit having a large relative entropy is reduced if it also has a large percent variation.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for classifying object sequences, comprising the computer implemented steps of:
obtaining a set of known aligned sequences, some of which form a first class exclusive of other sequences in the set, each known sequence in the set having a respective set of nᵢ elements, different elements possessing different physical properties from a respective set of qᵢ physical properties of interest, where i is sequence alignment position;
for each known sequence, forming a respective vector of qᵢ bits, a bit being set to 1 to indicate that a physical property is found in an element of the sequence and a bit being set to 0 to indicate that a physical property is absent from an element of the sequence;
for each bit, defining a profile as a function of the probability of the bit being set to 1;
given a test sequence to classify, forming a respective representative vector of q bits for the test sequence;
assigning a score for the test sequence as a function of the defined profiles per bit and the bit values in the representative vector of the test sequence; and
calculating, probability of the test sequence being of the first class as a function of the assigned score.

2. A method as claimed in claim 1 wherein the set of physical properties of interest include hydrophobicity, helix propensity, sheet propensity, hydrogen donor propensity , hydrogen acceptor propensity , the state of being charged, aromaticity, sidechain linearity unbranched, sidechain volume, Phi-Psi flexibility and crosslinkability.

3. A method as claimed in claim 1 wherein the step of defining'a profile includes defining probability of two terms LO(1) and LO(0) for each bit, where LO(1) is the log odds ratio of the probability of the bit being set to 1 given a sequence of the first class and the probability of the bit being set to 1 given a sequence not of the first class, and LO(0) is the log odds ratio of the probability of the bit being set to 0 given a sequence of the first class and the probability of the bit being set to 0 given a sequence not of the first class.

4. A method as claimed in claim 3 wherein the step of assigning a score includes:
for each bit in the representative vector of the test sequence, computing a birwise score equal to (the value of the bit multiplied by the product of the probability of the bit equaling 1 in the first class and LO(1) of the corresponding bit in the representative vector of a laiown sequence) plus the product of (1—value of the bit) and the product of the probability of the bit equaling 0 in the first class and LO(0) of the corresponding bit in the representative vector of the known sequence.

5. A method as claimed in claim 1 further comprising normalizing the assigned score; and
the step of calculating probability includes calculating Eq 22.

6. A method as claimed in claim 5 wherein the step of calculating probability further includes calculating probability that distribution of the normalized score of the test sequence is equal to distribution of normalized scores for the known sequences of the first class.


SEQUENCE LISTING (240 sequences)

SEQ ID NO: 1 - protein, 28 aa, Homo sapiens
KKHELYVSFRDLGWQDWIIAPEGYAAYY

SEQ ID NO: 2 - protein, 31 aa, Homo sapiens
AFPLNSYMNATNHAIVQTLVHFINPETVPKP

SEQ ID NO: 3 - protein, 34 aa, Homo sapiens
APTQLNAISVLYFDDSSNVILKKYRNMVVRACGC

SEQ ID NO: 4 - protein, 26 aa, Homo sapiens
CELYVSFRDLGWQDWIIAPEGYAAYC

SEQ ID NO: 5 - protein, 15 aa, Homo sapiens
CFRDLGWQDWIIAPC

SEQ ID NO: 6 - protein, 32 aa, Homo sapiens
CAFPLNSYMNATNHAIVQTLVHFINPETVPKC

SEQ ID NO: 7 - protein, 11 aa, Homo sapiens
CCFINPETVCC

SEQ ID NO: 8 - protein, 11 aa, Homo sapiens
CYFDDSSNVIC

SEQ ID NO: 9 - protein, 16 aa, Homo sapiens
CYFDDSSNVICKKYRS

SEQ ID NO: 10 - protein, 11 aa, Homo sapiens
CKKHELYVSFR

SEQ ID NO: 11 - protein, 23 aa, Homo sapiens
DLGWQDWIIAPEGYAAYYCEGEC

SEQ ID NO: 12 - protein, 11 aa, Homo sapiens
CKKHELYVSFR

SEQ ID NO: 13 - protein, 23 aa, Homo sapiens
DLGWQDWIIAPEGYAAFYCDGEC

SEQ ID NO: 14 - protein, 11 aa, Homo sapiens
CRKHELYVSFQ

SEQ ID NO: 15 - protein, 23 aa, Homo sapiens
DLGWQDWIIAPKGYAANYCDGEC

SEQ ID NO: 16 - protein, 11 aa, Homo sapiens
CQMQTLYIDFK

SEQ ID NO: 17 - protein, 23 aa, Homo sapiens
DLGWHDWIIAPEGYGAFYCSGEC

SEQ ID NO: 18 - protein, 11 aa, Homo sapiens
CKRHPLYVDFS

SEQ ID NO: 19 - protein, 23 aa, Homo sapiens
DVGWNDWIVAPPGYHAFYCHGEC

SEQ ID NO: 20 - protein, 11 aa, Homo sapiens
CRRHSLYVDFS

SEQ ID NO: 21 - protein, 23 aa, Homo sapiens
DVGWNDWIVAPPGYQAFYCHGDC

SEQ ID NO: 22 - protein, 11 aa, Homo sapiens
CRRHSLYVDFS

SEQ ID NO: 23 - protein, 23 aa, Homo sapiens
DVGWDDWIVAPLGYDAYYCHGKC

SEQ ID NO: 24 - protein, 11 aa, Homo sapiens
CCLYDLEIEFE

SEQ ID NO: 25 - protein, 4 aa, Homo sapiens
KIGW

SEQ ID NO: 26 - protein, 18 aa, Homo sapiens
DWIVAPPRYNAYMCRGDC

SEQ ID NO: 27 - protein, 11 aa, Homo sapiens
CCKKQFFVSFK

SEQ ID NO: 28 - protein, 23 aa, Homo sapiens
DIGWNDWIIAPSGYHANYCEGEC

SEQ ID NO: 29 - protein, 16 aa, Homo sapiens
CCVRQLYIDFRKDLGW

SEQ ID NO: 30 - protein, 18 aa, Homo sapiens
KWIHEPKGYHANFCLGPC

SEQ ID NO: 31 - protein, 16 aa, Homo sapiens
CCLRPLYIDFKRDLGW

SEQ ID NO: 32 - protein, 18 aa, Homo sapiens
KWIHEPKGYNANFCAGAC

SEQ ID NO: 33 - protein, 11 aa, Homo sapiens
CRARRLYVSFR

SEQ ID NO: 34 - protein, 23 aa, Homo sapiens
EVGWHRWVIAPRGFLANYCQGQC

SEQ ID NO: 35 - protein, 11 aa, Homo sapiens
CSRKALHVNFK

SEQ ID NO: 36 - protein, 23 aa, Homo sapiens
DMGWDDWIIAPLEYEAFHCEGLC

SEQ ID NO: 37 - protein, 11 aa, Homo sapiens
CSRKPLHVNFK

SEQ ID NO: 38 - protein, 23 aa, Homo sapiens
ELGWDDWIIAPLEYEAYHCEGVC

SEQ ID NO: 39 - protein, 11 aa, Homo sapiens
CSRKSLHVDFK

SEQ ID NO: 40 - protein, 23 aa, Homo sapiens
ELGWDDWIIAPLDYEAYHCEGVC

SEQ ID NO: 41 - protein, 11 aa, Homo sapiens
CARRYLKVDFA

SEQ ID NO: 42 - protein, 23 aa, Homo sapiens
DIGWSEWIISPKSFDAYYCSGAC

SEQ ID NO: 43 - protein, 11 aa, Homo sapiens
CRKVKFQVDFN

SEQ ID NO: 44 - protein, 23 aa, Homo sapiens
LIGWGSWIIYPKQYNAYRCEGEC

SEQ ID NO: 45 - protein, 11 aa, Homo sapiens
CSLHPFQISFR

SEQ ID NO: 46 - protein, 23 aa, Homo sapiens
QLGWDHWIIAPPFYTPNYCKGTC

SEQ ID NO: 47 - protein, 8 aa, Homo sapiens
AFPLNSYM

SEQ ID NO: 48 - protein, 17 aa, Homo sapiens
NATNHAIVQTLVHFINP

SEQ ID NO: 49 - protein, 8 aa, Homo sapiens
ETVPKPCC

SEQ ID NO: 50 - protein, 8 aa, Homo sapiens
SFPLNAHM

SEQ ID NO: 51 - protein, 17 aa, Homo sapiens
NATNHAIVQTLVHLMFP

SEQ ID NO: 52 - protein, 8 aa, Homo sapiens
DHVPKPCC

SEQ ID NO: 53 - protein, 8 aa, Homo sapiens
SFPLNAHM

SEQ ID NO: 54 - protein, 17 aa, Homo sapiens
NATNHAIVQTLVHLMNP

SEQ ID NO: 55 - protein, 8 aa, Homo sapiens
EYVPKPCC

SEQ ID NO: 56 - protein, 8 aa, Homo sapiens
NFPLNAHM

SEQ ID NO: 57 - protein, 17 aa, Homo sapiens
NATNHAIVQTLVHLLEP

SEQ ID NO: 58 - protein, 8 aa, Homo sapiens
KKVPKPCC

SEQ ID NO: 59 - protein, 8 aa, Homo sapiens
PFPLADHL

SEQ ID NO: 60 - protein, 17 aa, Homo sapiens
NSTNHAIVQTLVNSVNS

SEQ ID NO: 61 - protein, 7 aa, Homo sapiens
KIPKACC

SEQ ID NO: 62 - protein, 8 aa, Homo sapiens
PFPLADHL

SEQ ID NO: 63 - protein, 17 aa, Homo sapiens
NSTNHAIVQTLVNSVNS

SEQ ID NO: 64 - protein, 7 aa, Homo sapiens
SIPKACC

SEQ ID NO: 65 - protein, 8 aa, Homo sapiens
PFPLADHF

SEQ ID NO: 66 - protein, 17 aa, Homo sapiens
NSTNHAVVQTLVNNMNP

SEQ ID NO: 67 - protein, 8 aa, Homo sapiens
GKVPKACC

SEQ ID NO: 68 - protein, 9 aa, Homo sapiens
HYNAHHFNL

SEQ ID NO: 69 - protein, 17 aa, Homo sapiens
AETGHSKIMRAAHKVSN

SEQ ID NO: 70 - protein, 7 aa, Homo sapiens
PEIGYCC

SEQ ID NO: 71 - protein, 8 aa, Homo sapiens
PSHIAGTS

SEQ ID NO: 72 - protein, 29 aa, Homo sapiens
GSSLSFHSTVINHYRMRGHSPFANLKSCC

SEQ ID NO: 73 - protein, 5 aa, Homo sapiens
PYIWS

SEQ ID NO: 74 - protein, 17 aa, Homo sapiens
LDTQYSKVLALYNQHNP

SEQ ID NO: 75 - protein, 8 aa, Homo sapiens
GASAAPCC

SEQ ID NO: 76 - protein, 5 aa, Homo sapiens
PYLWS

SEQ ID NO: 77 - protein, 17 aa, Homo sapiens
SDTQHSRVLSLYNTINP

SEQ ID NO: 78 - protein, 8 aa, Homo sapiens
EASASPCC

SEQ ID NO: 79 - protein, 8 aa, Homo sapiens
ALPVALSG

SEQ ID NO: 80 - protein, 20 aa, Homo sapiens
SGGPPALNHAVLRALMHAAA

SEQ ID NO: 81 - protein, 9 aa, Homo sapiens
PGAADLPCC

SEQ ID NO: 82 - protein, 8 aa, Homo sapiens
EFPLRSHL

SEQ ID NO: 83 - protein, 17 aa, Homo sapiens
EPTNHAVIQTLMNSMDP

SEQ ID NO: 84 - protein, 8 aa, Homo sapiens
ESTPPTCC

SEQ ID NO: 85 - protein, 8 aa, Homo sapiens
DFPLRSHL

SEQ ID NO: 86 - protein, 17 aa, Homo sapiens
EPTNHAIIQTLMNSMDP

SEQ ID NO: 87 - protein, 8 aa, Homo sapiens
GSTPPSCC

SEQ ID NO: 88 - protein, 8 aa, Homo sapiens
DFPLRSHL

SEQ ID NO: 89 - protein, 17 aa, Homo sapiens
EPTNHAIIQTLLNSMAP

SEQ ID NO: 90 - protein, 8 aa, Homo sapiens
DAAPASCC

SEQ ID NO: 91 - protein, 8 aa, Homo sapiens
QFPMPKSL

SEQ ID NO: 92 - protein, 17 aa, Homo sapiens
KPSNHATIQSIVRAVGV

SEQ ID NO: 93 - protein, 9 aa, Homo sapiens
VPGIPEPCC

SEQ ID NO: 94 - protein, 8 aa, Homo sapiens
PNPVGEEF

SEQ ID NO: 95 - protein, 17 aa, Homo sapiens
HPTNHAYIQSLLKRYQP

SEQ ID NO: 96 - protein, 8 aa, Homo sapiens
HRVPSTCC

SEQ ID NO: 97 - protein, 8 aa, Homo sapiens
LRVLRDGI

SEQ ID NO: 98 - protein, 17 aa, Homo sapiens
NSFNHAIIQNLINQLVD

SEQ ID NO: 99 - protein, 8 aa, Homo sapiens
QSVPRPSC

SEQ ID NO: 100 - protein, 15 aa, Homo sapiens
PTQLNAISVLYFDDS

SEQ ID NO: 101 - protein, 19 aa, Homo sapiens
SNVILKKYRNMVVRACGCH

SEQ ID NO: 102 - protein, 15 aa, Homo sapiens
PTKLNAISVLYFDDS

SEQ ID NO: 103 - protein, 19 aa, Homo sapiens
SNVILKKYRNMVVRSCGCH

SEQ ID NO: 104 - protein, 15 aa, Homo sapiens
PTKLNAISVLYFDDN

SEQ ID NO: 105 - protein, 19 aa, Homo sapiens
SNVILKKYRNMVVRACGCH

SEQ ID NO: 106 - protein, 15 aa, Homo sapiens
PTRLGALPVLYHLND

SEQ ID NO: 107 - protein, 19 aa, Homo sapiens
ENVNLKKYRNMIVKSCGCH

SEQ ID NO: 108 - protein, 15 aa, Homo sapiens
PTELSAISMLYLDEN

SEQ ID NO: 109 - protein, 19 aa, Homo sapiens
EKVVLKNYQDMVVEGCGCR

SEQ ID NO: 110 - protein, 15 aa, Homo sapiens
PTELSAISMLYLDEY

SEQ ID NO: 111 - protein, 19 aa, Homo sapiens
DKVVLKNYQEMVVEGCGCR

SEQ ID NO: 112 - protein, 15 aa, Homo sapiens
PTQLDSVAMLYLNDQ

SEQ ID NO: 113 - protein, 19 aa, Homo sapiens
STVVLKNYQEMTVVGCGCR

SEQ ID NO: 114 - protein, 15 aa, Homo sapiens
PTEYDYIKLIYVNRD

SEQ ID NO: 115 - protein, 19 aa, Homo sapiens
GRVSIANVNGMIAKKCGCS

SEQ ID NO: 116 - protein, 15 aa, Homo sapiens
PTKLRPMSMLYYDDG

SEQ ID NO: 117 - protein, 19 aa, Homo sapiens
QNIIKKDIQNMIVEECGCS

SEQ ID NO: 118 - protein, 15 aa, Homo sapiens
PQALEPLPIVYYVGR

SEQ ID NO: 119 - protein, 18 aa, Homo sapiens
KPKVEQLSNMIVRSCKCS

SEQ ID NO: 120 - protein, 15 aa, Homo sapiens
SQDLEPLTILYYIGK

SEQ ID NO: 121 - protein, 18 aa, Homo sapiens
TPKIEQLSNMIVKSCKCS

SEQ ID NO: 122 - protein, 15 aa, Homo sapiens
PARLSPISVLFFDNS

SEQ ID NO: 123 - protein, 19 aa, Homo sapiens
DNVVLRQYEDMVVDECGCR

SEQ ID NO: 124 - protein, 15 aa, Homo sapiens
PTRLSPISILFIDSA

SEQ ID NO: 125 - protein, 19 aa, Homo sapiens
NNVVYKQYEDMVVESCGCR

SEQ ID NO: 126 - protein, 15 aa, Homo sapiens
PTKLTPISILYIDAG

SEQ ID NO: 127 - protein, 19 aa, Homo sapiens
NNVVYKQYEDMVVESCGCR

SEQ ID NO: 128 - protein, 15 aa, Homo sapiens
PARLSPISILYIDAA

SEQ ID NO: 129 - protein, 19 aa, Homo sapiens
NNVVYKQYEDMVVEACGCR

SEQ ID NO: 130 - protein, 15 aa, Homo sapiens
PEKMSSLSILFFDEN

SEQ ID NO: 131 - protein, 19 aa, Homo sapiens
KNVVLKVYPNMIVESCACR

SEQ ID NO: 132 - protein, 13 aa, Homo sapiens
PVKTKPLSMLYVD

SEQ ID NO: 133 - protein, 19 aa, Homo sapiens
GRVLLDHHKDMIVEECGCL

SEQ ID NO: 134 - protein, 15 aa, Homo sapiens
PYKYVPISVLMIEAN

SEQ ID NO: 135 - protein, 19 aa, Homo sapiens
GSILYKEYEGMIAESCTCR

SEQ ID NO: 136 - protein, 10 aa, Homo sapiens
CCCCCCCCCC

SEQ ID NO: 137 - protein, 10 aa, Homo sapiens
KKRRKCCASC

SEQ ID NO: 138 - protein, 10 aa, Homo sapiens
KRRKKVKRRR

SEQ ID NO: 139 - protein, 10 aa, Homo sapiens
HHHHHRKRKY

SEQ ID NO: 140 - protein, 10 aa, Homo sapiens
EPSEEQQYPP

SEQ ID NO: 141 - protein, 10 aa, Homo sapiens
LLLLLLFLLL

SEQ ID NO: 142 - protein, 10 aa, Homo sapiens
YYYYYYFKHT

SEQ ID NO: 143 - protein, 10 aa, Homo sapiens
VVVVVIVVVV

SEQ ID NO: 144 - protein, 10 aa, Homo sapiens
SDDSSDSDND

SEQ ID NO: 145 - protein, 10 aa, Homo sapiens
FFFFFFFFFF

SEQ ID NO: 146 - protein, 10 aa, Homo sapiens
RSSQRRKAKE

SEQ ID NO: 147 - protein, 10 aa, Homo sapiens
DDDDDDDDEA

SEQ ID NO: 148 - protein, 10 aa, Homo sapiens
LVVLLLIILF

SEQ ID NO: 149 - protein, 10 aa, Homo sapiens
GGGGGGGGGG

SEQ ID NO: 150 - protein, 10 aa, Homo sapiens
WWWWWWWWWW

SEQ ID NO: 151 - protein, 10 aa, Homo sapiens
QNNQQKNSDD

SEQ ID NO: 152 - protein, 5 aa, Homo sapiens
DDDDD

SEQ ID NO: 153 - protein, 10 aa, Homo sapiens
WWWWWWWWWW

SEQ ID NO: 154 - protein, 10 aa, Homo sapiens
IIIIIIIIII

SEQ ID NO: 155 - protein, 10 aa, Homo sapiens
IVVIIHIIII

SEQ ID NO: 156 - protein, 10 aa, Homo sapiens
AAAAAEASAA

SEQ ID NO: 157 - protein, 10 aa, Homo sapiens
PPPPPPPPPP

SEQ ID NO: 158 - protein, 10 aa, Homo sapiens
EPPKEKSKLK

SEQ ID NO: 159 - protein, 10 aa, Homo sapiens
GGGGGGGSER

SEQ ID NO: 160 - protein, 10 aa, Homo sapiens
YYYYYYYFYY

SEQ ID NO: 161 - protein, 10 aa, Homo sapiens
AHQAAHHDEK

SEQ ID NO: 162 - protein, 10 aa, Homo sapiens
AAAAAAAAAA

SEQ ID NO: 163 - protein, 10 aa, Homo sapiens
YFFNFNNYYN

SEQ ID NO: 164 - protein, 10 aa, Homo sapiens
YYYYYFYYHY

SEQ ID NO: 165 - protein, 10 aa, Homo sapiens
CCCCCCCCCC

SEQ ID NO: 166 - protein, 10 aa, Homo sapiens
EHHDDLESES

SEQ ID NO: 167 - protein, 10 aa, Homo sapiens
GGGGGGGGGG

SEQ ID NO: 168 - protein, 10 aa, Homo sapiens
EEDEEPEAVE

SEQ ID NO: 169 - protein, 10 aa, Homo sapiens
CCCCCCCCCC

SEQ ID NO: 170 - protein, 10 aa, Homo sapiens
APPSSPPQDE

SEQ ID NO: 171 - protein, 10 aa, Homo sapiens
FFFPFYSFFF

SEQ ID NO: 172 - protein, 10 aa, Homo sapiens
FFFFFIHPPV

SEQ ID NO: 173 - protein, 10 aa, Homo sapiens
LLLLLWIMLF

SEQ ID NO: 174 - protein, 10 aa, Homo sapiens
NAANNSAPRL

SEQ ID NO: 175 - protein, 5 aa, Homo sapiens
SDDAA

SEQ ID NO: 176 - protein, 4 aa, Homo sapiens
GKSQ

SEQ ID NO: 177 - protein, 5 aa, Homo sapiens
YHHHH

SEQ ID NO: 178 - protein, 4 aa, Homo sapiens
TSHK

SEQ ID NO: 179 - protein, 5 aa, Homo sapiens
MLLMM

SEQ ID NO: 180 - protein, 10 aa, Homo sapiens
NNNNNLSKEY

SEQ ID NO: 181 - protein, 10 aa, Homo sapiens
ASSAADLPPP

SEQ ID NO: 182 - protein, 10 aa, Homo sapiens
TTTTTTSSTH

SEQ ID NO: 183 - protein, 10 aa, Homo sapiens
NNNNNQENNT

SEQ ID NO: 184 - protein, 10 aa, Homo sapiens
HHHHHYHHHH

SEQ ID NO: 185 - protein, 10 aa, Homo sapiens
AAAAASSAAL

SEQ ID NO: 186 - protein, 10 aa, Homo sapiens
IIIIIKTTIV

SEQ ID NO: 187 - protein, 9 aa, Homo sapiens
VVVVVVIIH

SEQ ID NO: 188 - protein, 10 aa, Homo sapiens
QQQQQLIQQQ

SEQ ID NO: 189 - protein, 10 aa, Homo sapiens
TTTTTANSTA

SEQ ID NO: 190 - protein, 10 aa, Homo sapiens
LLLLLLHILN

SEQ ID NO: 191 - protein, 10 aa, Homo sapiens
VVVVVYYVMP

SEQ ID NO: 192 - protein, 10 aa, Homo sapiens
HNNHHNRRNR

SEQ ID NO: 193 - protein, 10 aa, Homo sapiens
FSSLLQMASG

SEQ ID NO: 194 - protein, 10 aa, Homo sapiens
IVVMMHRVMS

SEQ ID NO: 195 - protein, 10 aa, Homo sapiens
NNNNFNGGDA

SEQ ID NO: 196 - protein, 10 aa, Homo sapiens
PSSPPPHVPG

SEQ ID NO: 197 - protein, 6 aa, Homo sapiens
EDGFPG

SEQ ID NO: 198 - protein, 9 aa, Homo sapiens
TKSYHAAGS

SEQ ID NO: 199 - protein, 9 aa, Homo sapiens
VIIVVSNIT

SEQ ID NO: 200 - protein, 9 aa, Homo sapiens
PPPPPALPP

SEQ ID NO: 201 - protein, 9 aa, Homo sapiens
KKKKKAKEP

SEQ ID NO: 202 - protein, 10 aa, Homo sapiens
PAAPPPSPSP

SEQ ID NO: 203 - protein, 10 aa, Homo sapiens
CCCCCCCCCC

SEQ ID NO: 204 - protein, 10 aa, Homo sapiens
CCCCCCCCCC

SEQ ID NO: 205 - protein, 10 aa, Homo sapiens
AVVAAVVVVT

SEQ ID NO: 206 - protein, 10 aa, Homo sapiens
PPPPPPPPPP

SEQ ID NO: 207 - protein, 10 aa, Homo sapiens
TTTTTQTETT

SEQ ID NO: 208 - protein, 10 aa, Homo sapiens
QEEKKAKKKK

SEQ ID NO: 209 - protein, 10 aa, Homo sapiens
LLLLLLLMLM

SEQ ID NO: 210 - protein, 10 aa, Homo sapiens
NSSNNERSTS

SEQ ID NO: 211 - protein, 10 aa, Homo sapiens
AAAAAPPSPP

SEQ ID NO: 212 - protein, 10 aa, Homo sapiens
IIIIILMLII

SEQ ID NO: 213 - protein, 10 aa, Homo sapiens
SSSSSPSSSN

SEQ ID NO: 214 - protein, 10 aa, Homo sapiens
VMMVVIMIIM

SEQ ID NO: 215 - protein, 10 aa, Homo sapiens
LLLLLVLLLL

SEQ ID NO: 216 - protein, 10 aa, Homo sapiens
YYYYYYYFYY

SEQ ID NO: 217 - protein, 10 aa, Homo sapiens
FLLFFYYFIF

SEQ ID NO: 218 - protein, 10 aa, Homo sapiens
DDDDDVDDDN

SEQ ID NO: 219 - protein, 10 aa, Homo sapiens
DEEDDGDEAG

SEQ ID NO: 220 - protein, 5 aa, Homo sapiens
SNYNS

SEQ ID NO: 221 - protein, 4 aa, Homo sapiens
GNGK

SEQ ID NO: 222 - protein, 10 aa, Homo sapiens
SEDSSRQKNE

SEQ ID NO: 223 - protein, 10 aa, Homo sapiens
NKKNNKNNNQ

SEQ ID NO: 224 - protein, 10 aa, Homo sapiens
VVVVVPIVVI

SEQ ID NO: 225 - protein, 10 aa, Homo sapiens
IVVIIKIVVI

SEQ ID NO: 226 - protein, 10 aa, Homo sapiens
LLLLLVKLYY

SEQ ID NO: 227 - protein, 10 aa, Homo sapiens
KKKKKEKKKG

SEQ ID NO: 228 - protein, 10 aa, Homo sapiens
KNNKKQDVQK

SEQ ID NO: 229 - protein, 10 aa, Homo sapiens
YYYYYLIYYI

SEQ ID NO: 230 - protein, 10 aa, Homo sapiens
RQQRRSQPEP

SEQ ID NO: 231 - protein, 10 aa, Homo sapiens
NDENNNNNDA

SEQ ID NO: 232 - protein, 10 aa, Homo sapiens
MMMMMMMMMM

SEQ ID NO: 233 - protein, 10 aa, Homo sapiens
VVVVVIITVV

SEQ ID NO: 234 - protein, 10 aa, Homo sapiens
VVVVVVVVVV

SEQ ID NO: 235 - protein, 10 aa, Homo sapiens
REERRREEED

SEQ ID NO: 236 - protein, 10 aa, Homo sapiens
AGGASSESSR

SEQ ID NO: 237 - protein, 10 aa, Homo sapiens
CCCCCCCCCC

SEQ ID NO: 238 - protein, 10 aa, Homo sapiens
GGGGGKGAGG

SEQ ID NO: 239 - protein, 10 aa, Homo sapiens
CCCCCCCCCC

SEQ ID NO: 240 - protein, 10 aa, Homo sapiens
HRRHHSSRRS